(19) United States
(12) Patent Application Publication
(10) Pub. No.: US 2025/0329196 A1
(43) Pub. Date: Oct. 23, 2025

(54) CONTROL APPARATUS, CONTROL SYSTEM, AND CONTROL METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Shinya ABE, Kariya-city (JP); Yusuke MATSUMOTO, Tokyo (JP); Taiki SUZUKI, Tokyo (JP); Hiroaki SAKAKIBARA, Tokyo (JP)

(21) Appl. No.: 19/179,659

(22) Filed: Apr. 15, 2025

(30) Foreign Application Priority Data
Apr. 18, 2024 (JP) 2024-067698

(51) Int. Cl. G07C 5/00; B60W 50/02

(52) U.S. Cl. CPC G07C 5/008; B60W 50/0205; B60W 2555/20; B60W 2556/40; B60W 2556/45

(57) ABSTRACT

In a control apparatus, an acquisition unit receives, from a mobile object, a malfunction occurrence trigger indicative of an occurrence of at least one malfunction in driving assistance of the mobile object, and acquires, from the mobile object, in response to reception of the malfunction occurrence trigger, traveling-related information related to traveling of the mobile object. A control unit is configured to transmit, to an external device, malfunction information upon determination that a predetermined non-transmission requirement is not satisfied based on the traveling-related information, the malfunction information including positional information on the mobile object as malfunction positional information. The control unit is configured not to transmit, to the external device, the malfunction information upon determination that the predetermined non-transmission requirement is satisfied based on the traveling-related information.

### CROSS REFERENCE TO RELATED APPLICATION

This application is based on and claims the benefit of priority from Japanese Patent Application No. 2024-067698 filed on Apr. 18, 2024, the disclosure of which is incorporated in its entirety herein by reference.

### TECHNICAL FIELD

The present disclosure relates to control apparatuses, control systems, and control methods.

### BACKGROUND

Typical known technologies collect, from mobile objects, data to generate and/or update mobile-object control models used for driving assistance of the mobile objects. Japanese Patent Publication No. 7271237 discloses a technology that transmits data to an external server in response to cancellation of autonomous driving of a mobile object.

### SUMMARY

Users have requirements to reduce the frequency of data transmission from a mobile object to reduce communication costs of the mobile object.

The present disclosure aims to address such an issue described set forth above.

Specifically, an exemplary aspect of the present disclosure provides a control apparatus. The control apparatus includes an acquisition unit configured to receive, from a mobile object, a malfunction occurrence trigger indicative of an occurrence of at least one malfunction in driving assistance of the mobile object, and acquire, in response to reception of the malfunction occurrence trigger, traveling-related information related to traveling of the mobile object from the mobile object. The control apparatus includes a control unit configured to transmit, to an external device, malfunction information upon determination that a predetermined non-transmission requirement is not satisfied based on the traveling-related information, the malfunction information including positional information on the mobile object as malfunction positional information.

The control unit is configured not to transmit, to the external device, the malfunction information upon determination that the predetermined non-transmission requirement is satisfied based on the traveling-related information.

The control apparatus of the exemplary aspect is configured not to transmit, to the external device, the malfunction information upon determination that the predetermined non-transmission requirement is satisfied based on the traveling-related information.

This configuration of the mobile object therefore makes it possible to reduce the frequency of malfunction-information transmissions from the mobile object to the external device, thus reducing communication costs of the mobile object.

### BRIEF DESCRIPTION OF THE DRAWINGS

Other aspects of the present disclosure will become apparent from the following description of embodiments with reference to the accompanying drawings in which:

FIG. 1 is a block diagram illustrating a schematic configuration of a control system according to an exemplary embodiment of the present disclosure;

FIG. 2 is a flowchart schematically illustrating an example of a driving-action relevant data transmission routine and an example of a driving-action relevant data collection routine according to the exemplary embodiment;

FIG. 3 is a flowchart schematically illustrating an example of a malfunction information transmission determination routine and an example of a driving-action relevant data collection routine according to the exemplary embodiment; and

FIG. 4 is a flowchart schematically illustrating an example of a mobile-object control model generation/update routine according to the exemplary embodiment.

### DETAILED DESCRIPTION OF EMBODIMENT

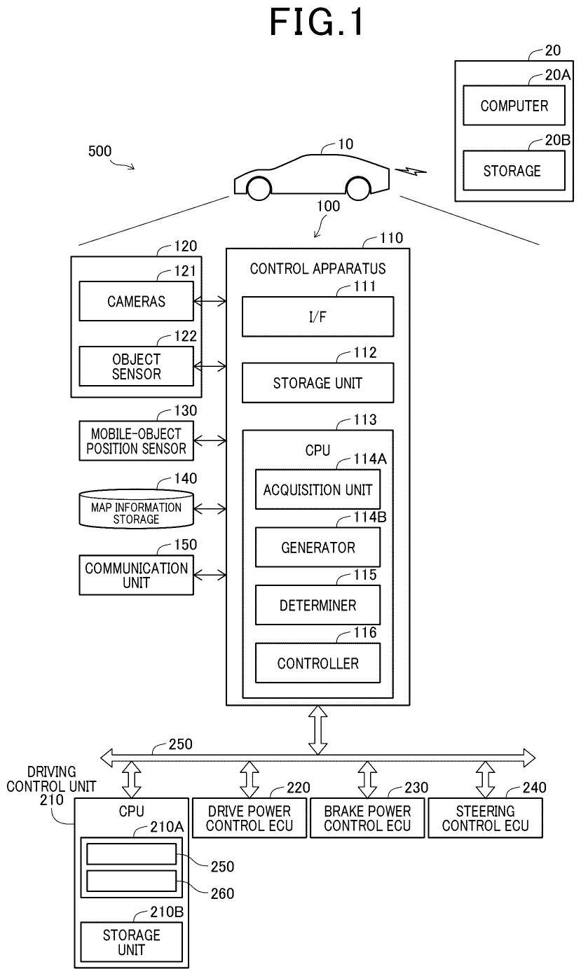

A control system 500 according to an exemplary embodiment includes, as illustrated in FIG. 1, a plurality of mobile objects 10, a server 20, and an autonomous-driving control system 100. The autonomous-driving control system 100 is installed in each mobile object 10. Each mobile object 10 according to the exemplary embodiment is a vehicle that can travel based on driving assistance, such as autonomous driving. Specifically, each mobile object 10 is, for example, an autonomous mobile object that travels in a selected one of an autonomous driving mode and a manual driving mode.

The autonomous-driving control system 100 of each mobile object 10 includes a present mobile-object control model installed therein. The autonomous-driving control system 100 of each mobile object 10 causes, based on the present mobile-object control model, the mobile object 10 to travel in the autonomous driving mode, i.e., travel autonomously.

The server 20 includes a computer 20A and a high-capacity storage 20B. The computer 20A of the server 20 is configured to iteratively access each mobile object 10 to iteratively collect, from the mobile object 10, actual driving-action relevant data. Then, the computer 20A of the server 20 is configured to store the received actual driving-action relevant data items collected from the mobile objects 10 in the high-capacity storage 20B.

The actual driving-action relevant data of each mobile object 10 includes, for example, positional data of the mobile object 10, actual driving-operation data of the mobile object 10, and surrounding environment data around the mobile object 10.

The positional data of the mobile object 10 includes, for example, a present coordinate position of the mobile object 10 measured by a vehicle position sensor 130 described later.

The actual driving-operation data of the mobile object 10 includes, for example, (i) a forward traveling operation to cause the corresponding mobile object 10 to travel in the forward direction, (ii) a rearward travelling operation to cause the mobile object 10 to travel in the rearward direction, (iii) a right turning operation to cause the mobile object 10 to turn rightward, (iv) a left turning operation to cause the mobile object 10 to turn leftward, (v) an accelerating operation to accelerate the mobile object 10, (vi) a braking operation to reduce the speed of the mobile object 10, and other various driving operations.

The surrounding environment data of the mobile object 10 includes, for example, traffic data indicative of traffics, such as one or more other mobile objects and one or more pedestrians, around the mobile object 10 and weather data indicative of the weather of the location in which the mobile object 10 is traveling.

The computer 20A of the server 20 is configured to generate, based on the actual driving-action relevant data items stored in the storage 20B, a new mobile-object control model that is usable for the autonomous-driving control system 100 of each mobile object 10. The new mobile-object control model installed in the autonomous-driving control system 100 of a selected mobile object 10 enables the autonomous-driving control system 100 of the selected mobile object 10 to cause the selected mobile object 10 to travel in the autonomous driving mode, i.e., to travel autonomously.

Additionally, the computer 20A of the server 20 is configured to update, based on the actual driving-action relevant data items stored in the storage 20B, the present mobile-object control model stored in the autonomous-driving control system 100 of each mobile object 10.

In particular, when at least one malfunction is determined to occur in driving assistance of any mobile object 10 at a particular location, the autonomous-driving control system 100 of the mobile object 10 is configured to generate malfunction information including, for example, (i) the detail of the at least one malfunction and (ii) positional information on the particular location, and send, to the server 20, the malfunction information. The particular location at which at least one malfunction is determined to occur in driving assistance of any mobile object 10 will also be referred to as a malfunction determination location hereinafter. The malfunction related to driving assistance of any mobile object 10 represents a condition where there is an impediment, a glitch, and/or unsatisfactory situation in the driving assistance, such as, the autonomous driving, of the mobile object 10.

In response to receiving the malfunction information sent from any mobile object 10, the computer 20A of the server 20 can be configured to store the malfunction information in the storage 20B. Then, the computer 20A of the server 20 can be configured to generate, based on the actual driving-action relevant data items and the malfunction information stored in the storage 20B, a new mobile-object control model or update the mobile-object control model stored in each mobile object 10 such that, when the new mobile-object control model or the updated mobile-object control model is installed in the mobile object 10, the new mobile-object control model or the updated mobile-object control model causes, before the mobile object 10 traveling in the autonomous driving mode reaches the malfunction determination location, the driving control unit 210 of the mobile object 10 to terminate the autonomous driving mode, and instruct a driver of the mobile object 10 to control operations of the mobile object 10 in the manual driving mode, i.e., instruct the driver of the mobile object 10 to manually drive the mobile object 10.

Each mobile object 10 includes the autonomous-driving control system 100 set forth above.

The autonomous-driving control system 100 of each mobile object 10 according to the exemplary embodiment is configured to perform autonomous driving operations of the mobile object 10 in the autonomous driving mode.

Specifically, the autonomous-driving control system 100 includes a control apparatus 110, a sensor unit 120, a mobile-object position sensor 130, a map information storage 140, a communication unit 150, a driving control unit 210, a drive power control electronic control unit (ECU) 220, a brake power control ECU 230, and a steering control ECU 240. The control apparatus 110 and the ECUs 210 to 240 are communicably connected to one another through a communication network 250 installed in the mobile object 10. Additionally, each of the control units 210 to 240 is communicably connected to the sensor unit 120, the mobile-object position sensor 130, the map information storage 140, and the communication unit 150 through the communication network 250 and/or an additional communication bus.

The sensor unit 120 of each mobile object 10 is configured to monitor traveling-related information related to traveling of the mobile object 10. The traveling-related information on each mobile object 10 includes, for example, surrounding environments around the mobile object 10 and the conditions of the driver of the mobile object 10. The surrounding environments around each mobile object 10 include, for example, the weather around the mobile object 10 and the degree of a traffic jam around the mobile object 10. The conditions of the driver include, for example, information indicative of whether the driver is awake, and whether the driver is frustrated.

The sensor unit 120 of each mobile object 10 according to the exemplary embodiment includes, for example, cameras 121 that include, for example, at least one surrounding camera 121 and at least one interior camera 121. The at least one surrounding camera 121 of each mobile object 10 is, for example, mounted to the body of the mobile object 10 and configured to capture images of a surrounding region around the mobile object 10. The at least one interior camera 121 is, for example, provided in the interior of the body of the mobile object 10 and configured to capture images of the interior of the body of the mobile object 10; the interior includes the driver of the mobile object 10.

The sensor unit 120 of each mobile object 10 according to the exemplary embodiment additionally includes, for example, at least one object sensor 122.

The at least one object sensor 122 of each mobile object 10 is configured to measure a relative distance of at least one object, which is located around the mobile object 10, from the mobile object 10. For example, as the at least one object sensor 122, at least one light detection and ranging (Lidar) or at least one millimeter-wave sensor can be used. The at least one Lidar is configured to emit laser pulses as probe waves, and receive reflections from at least one object located around the mobile object 10 based on the emitted laser pulses. Then, the at least one LiDAR is configured to analyze the received reflections to accordingly calculate a relative distance and/or a relative speed of the at least one object. The at least one millimeter-wave sensor is configured to emit millimeter waves as probe waves, and receive reflections from at least one object located around the mobile object 10 based on the emitted millimeter waves. Then, the at least one millimeter-wave sensor is configured to analyze the received reflections to accordingly calculate a relative distance and/or a relative speed of the at least one object to the mobile object 10.

The mobile-object position sensor 130 of each mobile object 10 is configured to detect a present coordinate position of the mobile object 10. For example, the mobile-object position sensor 130 is configured to detect, as the present coordinate position of the mobile object 10, coordinates of the present position of the mobile object 10 in a predetermined reference three-dimensional coordinate system, such as a world coordinate system, that is defined for the mobile object 10.

As the mobile-object position sensor 130, a global navigation satellite system (GNSS) device, such as a global positioning system (GPS) device, can be used, which is configured to receive GPS signals, which are sent from GPS satellites, and identify, based on the received GPS signals, the present coordinate position of the mobile object 10.

The map information storage 140 is configured to, for example, store map information while updating the map information in real time. For example, the map information includes
(I) Three-dimensional road position information items, each of which represents the longitudinal and latitudinal coordinates of a corresponding one of sections of a corresponding one of roads
(II) Three-dimensional natural/artificial feature position information items, each of which represents the three-dimensional longitudinal and latitudinal coordinates of a corresponding one of natural/artificial features, such as buildings or guardrails, on or around the roads
(III) Road-related information items, each of which is related to the corresponding one of the roads
(IV) Timestamp information items, i.e., Year/month/day/time information items, each of which represents the year, month, day, and time that the corresponding one of the information items (I), (II), and
(III) was updated

Each of the road-related information items related to the corresponding one of the roads includes, for example, (i) the type of the corresponding one of the roads, such as the public type or the private type, and (ii) the traffic volume of the corresponding one of the roads.

The communication unit 150 serves as an interface that enables the server 20 and the control apparatus 110 to wirelessly access one another.

The control apparatus 110 is configured to obtain, in response to receiving a driving-action transmission request sent from the server 20 through the communication unit 150, actual driving-action relevant data, and cause the communication unit 110 to transmit the actual driving-action relevant data to the server 20.

Additionally, the control apparatus 110 of each mobile object 10 is configured to generate, in response to determination that the occurrence of at least one malfunction in driving assistance of the mobile object 10 at a malfunction determination location, malfunction information including, for example, (i) the detail of the at least one malfunction and (ii) positional information on the malfunction determination location.

Then, the control apparatus 110 of each mobile object 10 is configured to determine whether to transmit, through the communication unit 150, the malfunction information to the server 20. The positional information on the malfunction determination location can be acquired from the mobile-object position sensor 130.

The control apparatus 110 is configured as, for example, a microcomputer comprised of, for example, an input/output (I/O) interface 111, a storage unit 112, and a CPU 113. The I/O interface (I/F) 111, storage unit 112, and CPU 113 are communicably connected to one another. The storage unit 112 is comprised of, for example, at least one ROM, at least one RAM, and/or other memories.

The CPU 113 is configured to execute programs, i.e., program instructions stored in the storage unit 112 to accordingly serve as an acquisition unit 114A, a generator 114B, a determiner 115, and a controller 116. A part or all of the functions 114, 115, and 116 can be implemented as a hardware circuit.

The generator 114B, determiner 115, and controller 116 can serve as a control unit according to the exemplary embodiment.

The acquisition unit 114A of each mobile object 10 is configured to receive, through the I/O interface 111, (i) the driving-relevant data transmission request sent from the server 20, (ii) a malfunction occurrence trigger indicative of the occurrence of at least one malfunction in driving assistance of the mobile object 10 from the driving control unit 210, and (iii) actual driving-action relevant data from, for example, the driving control unit 210, the brake power control ECU 230, the steering control ECU 240, the sensor unit 120, the mobile-object position sensor 130, and the map information storage 140.

Additionally, the acquisition unit 114A of each mobile object 10 is configured to acquire, in response to receiving the malfunction occurrence trigger, the traveling-related information, which includes (i) the surrounding environments around the mobile object 10, (ii) the conditions of the driver of the mobile object 10, (iii) the positional information on the mobile object 10 at the trigger reception timing as the malfunction determination location from the mobile-object position sensor 130, and (iv) map information on and around the malfunction determination location from the map information storage 140.

The generator 114B is configured to generate malfunction information in accordance with the malfunction occurrence trigger, the malfunction determination location, and the map information on and around the malfunction determination location. The malfunction information includes, for example, the detail of the at least one malfunction and the malfunction determination location on the corresponding map information.

The determiner 115 of each mobile object 10 is configured to determine whether a predetermined non-transmission requirement is satisfied based on the traveling-related information; the predetermined non-transmission requirement enables the determiner 115 to determine whether the malfunction information is required to be transmitted to the server 20. More specifically, the predetermined non-transmission requirement enables the determiner 115 to determine whether the malfunction information is required for generation of a new mobile-object control model and/or updating of the present mobile-object control model stored in the mobile object 10.

The malfunction information, which is not required for generation of a new mobile-object control model and/or updating of the present mobile-object control model stored in the mobile object 10, may include first exemplary information whose cause for the occurrence of the corresponding at least one malfunction in driving assistance of the mobile object 10 is likely to be unrelated to the malfunction determination location. Additionally, the malfunction information, which is not required for generation of a new mobile-object control model and/or updating of the present mobile-object control model stored in the mobile object 10, may include second information whose malfunction determination location is unlikely to be used for driving assistance, such as autonomous driving.

The controller 116 of each mobile object 10 is configured to obtain the actual driving-action relevant data of the mobile object 10 from, for example, the driving control unit 210, the brake power control ECU 230, the steering control ECU 240, the sensor unit 120, the mobile-object position sensor 130, and the map information storage 140, and transmit, through the communication unit 150, the actual driving-action relevant data of the mobile object 10 to the server 20.

Additionally, the controller 116 is configured to determine whether to transmit the malfunction information to the server 20. Specifically, the controller 116 is configured to instruct the communication unit 150 not to transmit the malfunction information to the server 20 upon determination that the predetermined non-transmission requirement is satisfied based on the traveling-related information. Otherwise, the controller 116 is configured to instruct the communication unit 150 to transmit the malfunction information to the server 20 upon determination that the predetermined non-transmission requirement is not satisfied based on the traveling-related information.

The driving control unit 210 of each mobile object 10 is configured as, for example, a microcomputer comprised of, for example, a CPU 210A and a storage unit 210B including, for example, at least one ROM and at least one RAM.

The storage unit 210B stores the present mobile-object control model.

The CPU 210A of the driving control unit 210 is programmed to control, in accordance with the present mobile-object control model, the ECUs 220, 230, and 240 using the traveling-related information monitored by the sensor unit 120 to accordingly perform, as the driving assistance of the mobile object 10, autonomous driving of the mobile object 10 in the autonomous driving mode.

Specifically, the CPU 210A of the driving control unit 210 is programmed to output, in accordance with the present mobile-object control model, control instructions to each of the ECUs 220, 230, and 240 using the traveling-related information monitored by the sensor unit 120. This causes the mobile object 10 to autonomously travel along a previously determined route in the autonomous driving mode.

For example, the CPU 210A of the driving control unit 210 outputs, if necessity arises, the control instruction to the drive power control ECU 220 using the traveling-related information monitored by the sensor unit 120 to accelerate the mobile object 10 safely. The CPU 210A of the driving control unit 210 outputs, if necessity arises, the control instruction to the brake power control ECU 230 using the traveling-related information monitored by the sensor unit 120 to decelerate the mobile object 10 safely. Additionally, the CPU 210A of the driving control unit 210 outputs, if necessity arises, the control instruction to the steering control ECU 240 using the traveling-related information monitored by the sensor unit 120 to cause the mobile object 10 to autonomously turn left, turn right, or make a lane change safely.

The CPU 210A of the driving control unit 210 is configured to serve as a determiner 250 to determine whether at least one malfunction has occurred in driving assistance, i.e., autonomous driving, of the mobile object 10.

Then, the CPU 210A of the driving control unit 210 is configured to, upon determination that at least one malfunction has occurred in driving assistance, i.e., autonomous driving, of the mobile object 10, serve as a transmitter 260 to transmit, to the control apparatus 110, the malfunction occurrence trigger with the detail of the at least one malfunction.

The at least one malfunction in the driving assistance of the mobile object 10 may include, for example, a malfunction related to generation of at least one of the control instructions and/or control itself of at least one of the ECUS 220 to 240 due to, for example, the external situations around the mobile object 10. Such a malfunction related to generation of at least one of the control instructions and/or control itself of at least one of the ECUS 220 to 240 may be directly due to one or more malfunctions in the mobile object 10 or indirectly due to
(I) A case where it is determined that a deviation of a position of at least one natural/artificial feature measured by the sensor unit 120 from a position of the corresponding at least one natural/artificial feature represented by the map information stored in the map information storage is greater than a predetermined allowable deviation threshold
(II) A case where it is determined that the mobile object 10 is unlikely to travel along a scheduled travel route due to a roadwork and/or fallen rocks
(III) A case where it is determined that the coordinates of the present position of the mobile object 10 measured by the mobile-object position sensor 130 have an accuracy lower than a predetermined allowable accuracy threshold due to, for example, a situation where the mobile object 10 being located in a congested urban zone or a tunnel

The CPU 210A of the driving control unit 210 according to the exemplary embodiment is configured to, upon determination that a malfunction related to generation of at least one of the control instructions to any of the ECUs 220 to 240 has occurred, transmit, to the control apparatus 110, the malfunction occurrence trigger with the detail of the at least one malfunction.

The drive power control ECU 220 of each mobile object 10 is configured to control one or more power sources, such as an engine and/or a motor, for generating driver power of the mobile object 10. Specifically, the drive power control ECU 220 is configured to control, in the manual driving mode, operations of the one or more power sources in accordance with a driver's operation amount of an accelerator pedal of the mobile object 10 to accordingly cause the one or more power sources to generate drive power based on the driver's operation amount of the accelerator pedal for accelerating the mobile object 10. Additionally, the drive power control ECU 220 is configured to control, in the autonomous driving mode, operations of the one or more power sources in accordance with requested drive power determined by the driving control unit 210 to accordingly cause the one or more power sources to generate drive power based on the requested drive power for accelerating the mobile object 10.

The brake power control ECU 230 of each mobile object 10 configured to control one or more brake actuators for generating brake power of the mobile object 10. Specifically, the brake power control ECU 230 is configured to control, in the manual driving mode, operations of the one or more brake actuators in accordance with a driver's operation amount of a brake pedal of the mobile object 10 to accordingly cause the one or more brake actuators to generate brake power based on the driver's operation amount of the brake pedal for decelerating the mobile object 10. Additionally, the brake power control ECU 230 is configured to control, in the autonomous driving mode, operations of the one or more brake actuators in accordance with requested brake power determined by the driving control unit 210 to accordingly cause the one or more brake actuators to generate brake power based on the requested brake power for decelerating the mobile object 10.

The steering control ECU 240 of each mobile object 10 is configured to control a motor for generating assist torque used to steer the mobile object 10. Specifically, the steering control ECU 240 is configured to control, in the manual driving mode, operations of the motor in accordance with a driver's operation of a steering wheel of the mobile object 10 to accordingly cause the motor to generate assist torque that assists the driver's operation of the steering wheel. This enables the driver to operate the steering wheel using a smaller amount of force to steer the mobile object 10.

Additionally, the steering control ECU 240 of each mobile object 10 is configured to control, in the autonomous driving mode, operations of the motor in accordance with a requested steering angle determined by the driving control unit 210 to accordingly steer the mobile object 10.

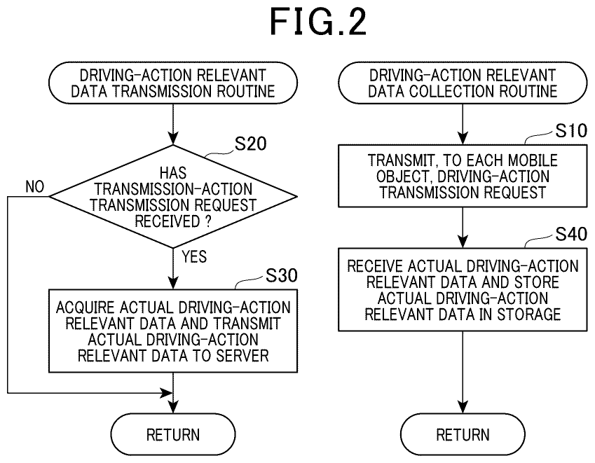

Next, the following describes a driving-action relevant data collection routine carried out by the server 20 and a driving-action relevant data transmission routine carried out by the control apparatus 110 with reference to FIG. 2. The server 20 is programmed to cyclically execute the driving-action relevant data collection routine every predetermined period. The control apparatus 110 of each mobile object 10 is programmed to cyclically execute the driving-action relevant data transmission routine every predetermined period during traveling of the corresponding mobile object 10.

When starting the driving-action relevant data collection routine, the computer 20A of the server 20 transmits, to the control apparatus 110 of each mobile object 20, the driving-action transmission request in step S10 of FIG. 2.

When starting the driving-action relevant data transmission routine, the CPU 113 of each mobile object 10 determines whether the acquisition unit 114A has received the driving-action transmission request from the server 20 through the communication unit 150 in step S20. In response to determination that the acquisition unit 114A has not received the driving-action transmission request from the server 20 (NO in step S20), the CPU 113 terminates the present cycle of the driving-action relevant data transmission routine, and executes the next cycle of the driving-action relevant data transmission routine after lapse of the predetermined period.

Otherwise, in response to determination that the acquisition unit 114A has received the driving-action transmission request from the server 20 (YES in step S20), the driving-action relevant data transmission routine proceeds to step S30.

In step S30, the CPU 113 of each mobile object 10 serves as the acquisition unit 114A to access the ECUs 220 to 240, the sensor unit 120, the vehicle position sensor 130, and the map information storage 140 to accordingly acquire, from the ECUs 220 to 240, the sensor unit 120, the vehicle position sensor 130, and the map information storage 140, the actual driving-action relevant data of the mobile object 10 that includes, for example, the positional data of the mobile object 10, the actual driving-operation data of the mobile object 10, and the surrounding environment data around the mobile object 10.

Then, the CPU 113 each mobile object 10 serves as the controller 116 to transmit, to the server 20 through the communication unit 150, the actual driving-action relevant data of the mobile object 10 in step S30, and thereafter terminates the present cycle of the driving-action relevant data transmission routine and executes the next cycle of the driving-action relevant data transmission routine after lapse of the predetermined period.

When the actual driving-action relevant data of each mobile object 10 is transmitted to the server 20 from the mobile object 10, the computer 20A of the server 20 receives the actual driving-action relevant data of the mobile object 10, and stores the actual driving-action relevant data items of the respective mobile objects 10 in the storage 20B in step S40, and thereafter terminates the present cycle of the driving-action relevant data collection routine and executes the next cycle of the driving-action relevant data collection routine after lapse of the predetermined period.

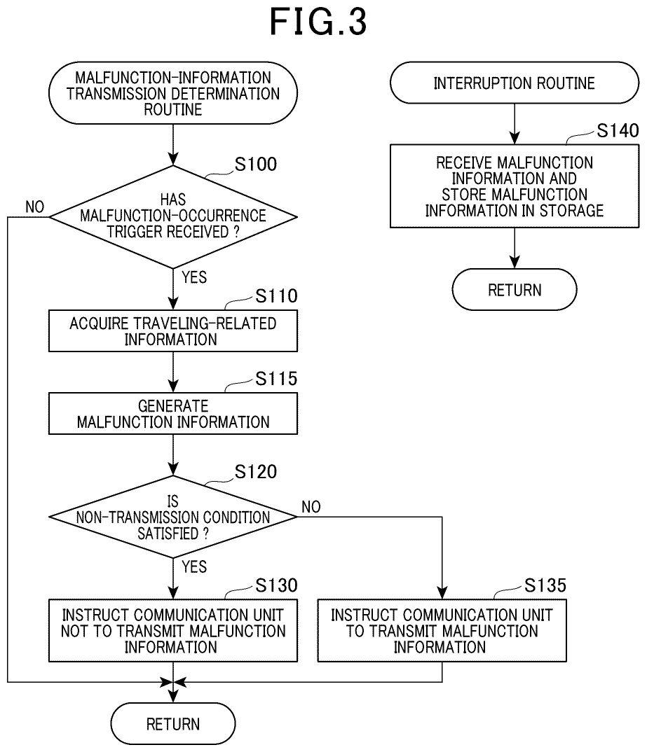

Next, the following g describes a malfunction-information transmission determination routine carried out by the control apparatus 110 with reference to FIG. 3 and a malfunction information reception routine carried out by the server 20 with reference to FIG. 3. The control apparatus 110 of each mobile object 10 is programmed to cyclically execute the malfunction-information transmission determination routine every predetermined period, such as 100 milliseconds, during traveling of the corresponding mobile object 10.

When starting the malfunction-information transmission determination routine, the CPU 113 of each mobile object 10 determines whether the acquisition unit 114A has received a malfunction occurrence trigger from the driving control unit 210 in step S100 of FIG. 3. The operation in step S100 serves as, for example, a first determination step.

The malfunction occurrence trigger for each mobile object 10 represents the occurrence of at least one malfunction in driving assistance, i.e., autonomous driving, of the mobile object 10.

In response to determination that the acquisition unit 114A has received no malfunction occurrence triggers from the driving control unit 210 (NO in step S100), the CPU 113 of each mobile object 10 terminates the present cycle of the malfunction-information transmission determination routine, and executes the next cycle of the malfunction-information transmission determination routine after lapse of the predetermined period.

Otherwise, in response to determination that the acquisition unit 114A of at least one mobile object 10 has received the malfunction occurrence trigger from the driving control unit 210 (YES in step S100), the malfunction-information transmission determination routine proceeds to step S110.

In step S110, the CPU 113 of the at least one mobile object 10 serves as the acquisition unit 114A to acquire, in response to receiving the malfunction occurrence trigger, the traveling-related information, which includes (i) the surrounding environments around the mobile object 10, (ii) the conditions of the driver of the mobile object 10, (iii) the positional information on the mobile object 10 at the trigger reception timing as the malfunction determination location from the mobile-object position sensor 130, and (iv) map information on and around the malfunction determination location from the map information storage 140. The operation in step S110 serves as, for example, an acquisition step. The operations in steps S100 and S110 can be parallelly carried out.

As described above, the traveling-related information on the at least one mobile object 10 includes, for example, the surrounding environments around the at least one mobile object 10 and the conditions of the driver of the at least one mobile object 10.

The malfunction determination location related to at least one malfunction may include, for example, at least one of (i) positional information at which an actual malfunction has occurred and (ii) positional information on the mobile object 10 at which it is determined that at least one malfunction has occurred.

Following the operation in step S110, the CPU of the at least one mobile object 10 serves as the generator 114B to generate malfunction information in accordance with the malfunction occurrence trigger, the malfunction determination location, and the map information on and around the malfunction determination location in step S115. The malfunction information includes, for example, the detail of the at least one malfunction and the malfunction determination location on the corresponding map information.

Following the operation in step S115, the CPU 113 of the at least one mobile object 10 serves as the determiner 115 to determine whether the predetermined non-transmission requirement is satisfied based on the traveling-related information on the at least one mobile object 10 in step S120.

The non-transmission requirement is commonly defined for each mobile object 10.

For example, the CPU 113 of the at least one mobile object 10 according to the exemplary embodiment uses the following first to sixth conditions as information for determining whether the predetermined non-transmission requirement is satisfied.

Then, the CPU 113 of the at least one mobile object 10 serves as the determiner 115 to
(I) Determine whether at least one of the first to sixth conditions is satisfied based on the traveling-related information on the at least one mobile object 10
(II) Determine that the predetermined non-transmission requirement is satisfied upon determination that at least one of the first to sixth conditions is satisfied based on the traveling-related information on the at least one mobile object 10

Other conditions can be used as the non-transmission requirement. The combination of selected ones of the first to sixth conditions can be used as information for determining whether the predetermined non-transmission requirement is satisfied.

The first condition defined for each mobile object 10 is that the weather around the mobile object 10 included in the traveling-related information on the mobile object 10 is one of bad weathers.

The second condition defined for each mobile object 10 is that the last updated timestamp information on the three-dimensional road position information item related to the road to which the malfunction determination location belongs is on and after a predetermined threshold year/month/day/time. The road to which the malfunction determination location belongs will also be referred to as a malfunction-related road.

The third condition defined for each mobile object 10 is that the driver of the mobile object 10 is not frustrated.

The fourth condition defined for each mobile object 10 is that the malfunction-related road is a private road or a blind alley.

The fifth condition defined for each mobile object 10 is that the traffic volume of the malfunction-related road is smaller than or equal to a predetermined threshold traffic volume.

The sixth condition defined for each mobile object 10 is that at least one alternative road, which satisfies a predetermined requirement, is provided in parallel to the malfunction-related road.

Let us assume that the first condition is satisfied, i.e., the weather around the mobile object 10 included in the traveling-related information on the mobile object 10 is a bad weather including, for example, at least one of rainfall, fog, haze, and thunder. In this assumption, the field of view of, for example, each of the cameras 121 and the at least one object sensor 122 is likely to be poor. For this reason, if the first condition is satisfied, the cause of the occurrence of the malfunction in driving assistance of the mobile object 10 is unlikely to be due to the malfunction determination point but likely due to a bad weather.

If the second condition is satisfied, the three-dimensional road position information item on the malfunction-related road is likely to have been updated recently. This results in the control instructions for driving assistance of the mobile object 10 being likely to be generated based on the real road situations around the mobile object 10. For this reason, if the second condition is satisfied, the cause of the occurrence of the malfunction in driving assistance of the mobile object 10 is unlikely due to the malfunction determination point but likely to be due to another cause. For example, the predetermined threshold year/month/day/time can be set to one month before the timing at which at least one malfunction is determined to occur at the malfunction determination location.

If the driver of any mobile object 10 makes negative sounds or negative voices, such as clicking sounds with the driver's tongue and/or rude comments, the determiner 115 of the control apparatus 110 determines that the third condition defined for the mobile object 10 is not satisfied, i.e., the determiner 115 of the control apparatus 110 determines that the driver of the mobile object 10 is frustrated. For this reason, if the third condition is not satisfied, the cause of the occurrence of the malfunction in driving assistance of the mobile object 10 is likely due to the malfunction determination point. In other wors, if the third condition is satisfied, the cause of the occurrence of the malfunction in driving assistance of the mobile object 10 is unlikely due to the malfunction determination point but likely due to another cause.

If the fourth condition is satisfied, i.e., the malfunction-related road is a private road or a blind alley, driving assistance, i.e., autonomous driving, of the mobile object 10 is unlikely to be performed on the road.

The threshold traffic volume included in the fifth condition can be set to a fixed value or set to be variable depending on the day and time at which the determination in step S120 is executed. If the fifth condition is satisfied, i.e., the traffic volume of the malfunction-related road is smaller than or equal to the threshold traffic volume, it is determined that the malfunction-related road is not to be used due to, for example, a roadwork of the malfunction-related road and/or fallen rocks on the malfunction-related road, so that driving assistance, i.e., autonomous driving, of the mobile object 10 is unlikely to be possible on the malfunction-related road.

If at least one alternative road located in parallel to the malfunction-related road satisfies the predetermined requirement, the at least one alternative road has a wider width in that of the malfunction-related road and has been constructed newer than the malfunction-related road. That is, if the sixth condition is satisfied, i.e., the at least one alternative road located in parallel to the malfunction-related road satisfies the predetermined requirement, driving assistance, i.e., autonomous driving, of the mobile object 10 is unlikely to be performed on the malfunction-related road.

In response to determination that the predetermined non-transmission requirement is satisfied based on the traveling-related information on the at least one mobile object 10, i.e., any one of the first to sixth conditions is satisfied (YES in step S120), the malfunction-information transmission determination routine proceeds to step S130.

In step S130, the CPU 113 of the at least one mobile object 10 serves as the controller 116 to instruct the communication unit 150 not to transmit, to the server 20, malfunction information related to the at least one malfunction, and thereafter, the CPU 113 terminates the present cycle of the malfunction-information transmission determination routine, and executes the next cycle of the malfunction-information transmission determination routine after lapse of the predetermined period.

Otherwise, in response to determination that the predetermined non-transmission requirement is not satisfied based on the traveling-related information on the at least one mobile object 10, i.e., none of the first to sixth conditions is satisfied (NO in step S120), the malfunction-information transmission determination routine proceeds to step S135.

In step S135, the CPU 113 of the at least one mobile object 10 serves as the controller 116 to instruct the communication unit 150 to transmit, to the server 20, the malfunction information generated in step S115, and thereafter, the CPU 113 terminates the present cycle of the malfunction-information transmission determination routine, and executes the next cycle of the malfunction-information transmission determination routine after lapse of the predetermined period.

The operations in steps S120 to S135 serve as, for example, a second determination step.

While the server 20 cyclically executes the driving-action relevant data collection routine, when the malfunction information is transmitted to the server 20 from the selected mobile object 10, the computer 20A of the server 20 is programmed to execute an interrupt routine illustrated in FIG. 3.

When starting the interruption routine, the computer 20A of the server 20 receives the malfunction information transmitted from the selected mobile object 10, and stores the malfunction information in the storage 20B in step S140.

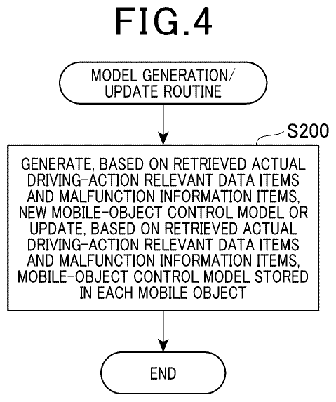

Next, the following describes a mobile-object control model generation/update routine carried out by the server 20 with reference to FIG. 4.

When starting the mobile-object control model generation/update routine, the computer 20A of the server 20 retrieves, from the storage 20B, the actual driving-action relevant data items and the malfunction information items in step S200.

Then, the computer 20A of the server 20 generates, based on the retrieved actual driving-action relevant data items and malfunction information items, a new mobile-object control model. When the new mobile-object control model is installed any mobile object 10 traveling in the autonomous driving mode, the new mobile-object control model causes, before any mobile object 10 reaches the malfunction determination location on the corresponding map information included in each of the malfunction information items, the autonomous-driving control system 100 of the mobile object 10 to terminate the autonomous driving mode, and instruct a driver of the mobile object 10 to control operations of the mobile object 10 in the manual driving mode, i.e., instruct the driver of the mobile object 10 to manually drive the mobile object 10 in step S210.

Alternatively, the computer 20A of the server 20 updates, based on the retrieved actual driving-action relevant data items and malfunction information items, the mobile-object control model stored in each mobile object 10. The updated mobile-object control model causes, before the mobile object 10 traveling in the autonomous driving mode reaches the malfunction determination location on the corresponding map information included in each of the malfunction information items, the driving control unit 210 of the mobile object 10 to terminate the autonomous driving mode, and instruct the driver of the mobile object 10 to control operations of the mobile object 10 in the manual driving mode, i.e., instruct the driver of the mobile object 10 to manually drive the mobile object 10 in step S210. After the operation in step S20, the computer 20A of the server 20 terminates the mobile-object control model generation/update routine.

The control apparatus 110 of any mobile object 10 described set forth above is configured to acquire, in response to receiving the malfunction occurrence trigger, (i) the positional information on the mobile object 10 at the trigger reception timing as the malfunction determination location from the mobile-object position sensor 130, (ii) the traveling-related information, which includes the surrounding environments around the mobile object 10 and the conditions of the driver of the mobile object 10, from the sensor unit 120, and (iii) map information on and around the malfunction determination location from the map information storage 140.

Additionally, the control apparatus 110 of any mobile object 10 is configured to generate malfunction information in accordance with the malfunction occurrence trigger, the malfunction determination location, and the map information on and around the malfunction determination location.

The control apparatus 110 of any mobile object 10 is configured to determine whether the predetermined non-transmission requirement is satisfied based on the traveling-related information on the mobile object 10. That is, the control apparatus 110 of any mobile object 10 is configured not to transmit, to the server 20, the malfunction information in response to determination that the predetermined non-transmission requirement is satisfied based on the traveling-related information on the mobile object 10. Otherwise, the control apparatus 110 of any mobile object 10 is configured to transmit, to the server 20, the malfunction information in response to determination that the predetermined non-transmission requirement is not satisfied based on the traveling-related information on the mobile object 10.

This configuration of each mobile object 10 therefore makes it possible to reduce the frequency of malfunction-information transmissions from the mobile object 10 to the server 20, thus reducing communication costs of the mobile object 10.

### Modifications

The acquisition unit 114A is configured to acquire the traveling-related information from the sensor unit 120, but can be configured to acquire, through the communication unit 150, the traveling-related information from an external server, such as the server 20, when the external server, such as the server 20, can be configured to collect such traveling-related information.

The acquisition unit 114A can be configured to acquire the traveling-related information directly from the sensor unit 120 or extract, from various information items monitored by the sensor unit 120, the traveling-related information.

For example, the sensor unit 120 can be configured to analyze one or more images captured by at least one of the cameras 121 to accordingly acquire the surrounding environments around the mobile object 10. Alternatively, the acquisition unit 114A can be configured to analyze one or more images captured by at least one of the cameras 121 to accordingly acquire the surrounding environments around the mobile object 10.

The control apparatus 110 according to the exemplary embodiment, which includes the acquisition unit 114A, the generator 114B, the determiner 115, and the controller 116, can be modified to include at least the controller 116 without including the acquisition unit 114A, the generator 114B, and the determiner 115. In this modification, one or more microcomputers, each of which is comprised of a CPU and a storage unit, different from the microcomputer constituting the control apparatus 110 can implement the acquisition unit 114A, the generator 114B, and the determiner 115.

The control apparatus 110 according to the exemplary embodiment is installed in each mobile object 10, but the present disclosure is not limited thereto. Specifically, the control apparatus 110 can be provided outside the mobile objects 10, and can be configured to access the sensor unit 120, the mobile-object position sensor 130, the map information storage 140, the driving control unit 210, the brake power control ECU 230, and the steering control ECU 240 of each mobile object 10 to accordingly execute the driving-action relevant data transmission routine illustrated in FIG. 2 and the malfunction information reception routine illustrated in FIG. 3.

The control apparatus 110 according to the exemplary embodiment can be configured to include the communication unit 150. That is, the control apparatus 110 can serve as the communication unit 150 to wirelessly access the server 20.

In step S135, the CPU 113 of the control apparatus 110 according to the exemplary embodiment can be configured to transmit, to the server 20 through the communication unit 115, the malfunction information that can include (i) the traveling-related information acquired in step S110 and (ii) one or more images captured by at least one camera 121 at the malfunction determination location in addition to the detail of the at least one malfunction and the malfunction determination location on the corresponding map information.

The present disclosure is not limited to the above exemplary embodiment and its modification, and can be implemented by various configurations within the scope of the present disclosure. For example, technical features included in the exemplary embodiment and its modifications, which correspond to technical features included in the exemplary aspect described in the SUMMARY of the present disclosure, can be freely combined with each other or can be freely replaced with another feature in order to solve a part or all of the above issue and/or achieve a part or all of the above advantageous benefits. One or more of the technical features included in the above exemplary embodiment and its modifications, which are not described as essential elements in the specification, can be omitted as necessity arises.

The control apparatuses and their control methods according to the present disclosure can be implemented by a dedicated computer including a memory and a processor programmed to perform one or more functions embodied by one or more computer programs.

The control apparatuses and their control methods according to the present disclosure can also be implemented by a dedicated computer including a processor comprised of one or more dedicated hardware logic circuits.

The control apparatuses and their control methods according to the present disclosure according to the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer or a processor.

1. A control apparatus comprising:
an acquisition unit configured to:
receive, from a mobile object, a malfunction occurrence trigger indicative of an occurrence of at least one malfunction in driving assistance of the mobile object; and
acquire, from the mobile object, in response to reception of the malfunction occurrence trigger, traveling-related information related to traveling of the mobile object; and
a control unit configured:
to transmit, to an external device, malfunction information upon determination that a predetermined non-transmission requirement is not satisfied based on the traveling-related information, the malfunction information including positional information on the mobile object as malfunction positional information; and
not to transmit, to the external device, the malfunction information upon determination that the predetermined non-transmission requirement is satisfied based on the traveling-related information.

2. The control apparatus according to claim 1, wherein:
the traveling-related information includes surrounding-environment information indicative of surrounding environments around the mobile object; and
the control unit is configured to determine that the predetermined non-transmission requirement is satisfied when a weather around the mobile object included in the surrounding-environment information is one of bad weathers.

3. The control apparatus according to claim 1, wherein:
the acquisition unit is configured to acquire map information on a map used by the driving assistance, the map information being literately updated;
the traveling-related information includes the malfunction positional information; and
the control unit is configured to determine that the predetermined non-transmission requirement is satisfied when a last updated day and time of a part of the map information is on and after a predetermined threshold day and time, the part of the map information including the malfunction positional information.

4. The control apparatus according to claim 1, wherein:
the traveling-related information includes road information on a road to which the malfunction positional information belongs; and
the control unit is configured to determine that the predetermined non-transmission requirement is satisfied when the driving assistance is unlikely to be possible on the road.

5. The control apparatus according to claim 1, wherein:
the traveling-related information includes information includes driver information indicative of a condition of a driver of the mobile object; and
the control unit is configured to determine that the predetermined non-transmission requirement is satisfied upon determination that the driver is not frustrated based on the driver information.

6. A system comprising:
at least one mobile object;
an acquisition unit configured to:
receive, from the at least one mobile object, a malfunction occurrence trigger indicative of an occurrence of at least one malfunction in driving assistance of the at least one mobile object; and
acquire, from the mobile object, in response to reception of the malfunction occurrence trigger, traveling-related information related to traveling of the mobile object;
a determiner configured to determine whether a predetermined non-transmission requirement is satisfied based on the traveling-related information on the at least one mobile object; and
a control unit configured:
to transmit, to an external device, malfunction information upon determination that a predetermined non-transmission requirement is not satisfied based on the traveling-related information, the malfunction information including positional information on the mobile object as malfunction positional information; and
not to transmit, to the external device, the malfunction information upon determination that the predetermined non-transmission requirement is satisfied based on the traveling-related information.

7. The system according to claim 6, further comprising:
the external device, wherein:
the external device comprises a computer and a storage;
the computer of the external device is configured to:
access the at least one mobile object to iteratively collect, from the at least one mobile object, actual driving-action relevant data that includes positional data of the at least one mobile object, actual driving-operation data of the at least one mobile object, and surrounding environment data around the at least one mobile object;
perform at least one of:
updating of a driving-assist control model stored in the storage based on the collected actual driving-action relevant data items and the malfunction information on the at least one mobile object, the driving-assist control model being used for driving assistance of the at least one mobile object; and
generation of a new driving-assist control model used for driving assistance of the at least one mobile object based on the collected actual driving-action relevant data items and the malfunction information on the at least one mobile object.

8. The system according to claim 7, wherein:
the at least one mobile object includes a driving control unit configured to cause the at least one mobile object to travel in a selected one of an autonomous driving mode and a manual driving mode; and
when one of the updated driving-assist control model and the generated new driving-assist control model is installed in the at least one mobile object that is traveling in the autonomous driving mode, one of the updated driving-assist control model and the generated new driving-assist control model is configured to cause, before the at least one object reaches a position based on the malfunction position information, the driving control unit to terminate the autonomous driving mode and instruct a driver of the mobile object to control operations of the at least one mobile object in the manual driving mode.

9. A method of controlling a mobile object, the method comprising:
receiving, from a mobile object, a malfunction occurrence trigger indicative of an occurrence of at least one malfunction in driving assistance of the mobile object;
acquiring, from the mobile object, in response to reception of the malfunction occurrence trigger, traveling-related information related to traveling of the mobile object;
determining to transmit, to an external device, malfunction information upon determination that a predetermined non-transmission requirement is not satisfied based on the traveling-related information, the malfunction information including positional information on the mobile object as malfunction positional information; and
determining not to transmit, to the external device, the malfunction information upon determination that the predetermined non-transmission requirement is satisfied based on the traveling-related information.

10. A program product for controlling a mobile object, the program product comprising a non-transitory storage medium that stores program instructions that cause a processor included in the mobile object to:
receive, from the mobile object, a malfunction occurrence trigger indicative of an occurrence of at least one malfunction in driving assistance of the mobile object;
acquire, from the mobile object, in response to reception of the malfunction occurrence trigger, traveling-related information related to traveling of the mobile object;
determine to transmit, to an external device, malfunction information upon determination that a predetermined non-transmission requirement is not satisfied based on the traveling-related information, the malfunction information including positional information on the mobile object as malfunction positional information; and
determine not to transmit, to the external device, the malfunction information upon determination that the predetermined non-transmission requirement is satisfied based on the traveling-related information.
